(19) United States
(12) Patent Application Publication
(10) Pub. No.: US 2026/0302813 A1
(43) Pub. Date: Oct. 1, 2026

(54) BATTERY CHARGER WITH HANDLE

(71) Applicant: MILWAUKEE ELECTRIC TOOL CORPORATION, Brookfield, WI (US)

(72) Inventors: Carson G. Taylor, Madison, WI (US); Keith G. Koch, Kenosha, WI (US); Olivia M. Duero, Wauwatosa, WI (US); Jacob D. Rosenthal, Brookfield, WI (US); Joel D. Snyder, Menomonee Falls, WI (US)

(21) Appl. No.: 19/632,521

(22) Filed: Mar. 30, 2026

Related U.S. Application Data
(60) Provisional application No. 63/779,874, filed on Mar. 28, 2025.

(51) Int. Cl. H02J 7/70; H02J 7/50

(52) U.S. Cl. CPC H02J 7/751; H02J 7/50

(57) ABSTRACT

A battery charger may include a housing including a base and a column extending from the base in a height direction, the column including a distal end opposite the base. The battery charger may include a plurality of battery interfaces located on at least one of the base or the column, each battery interface of the plurality of battery interfaces configured to receive a battery and provide power to the battery for charging the battery. The battery charger may include a handle assembly coupled to the distal end of the column, the handle assembly including a handle configured to be grasped by a user to carry the battery charger. The handle may be movable relative to the housing between a retracted position and an extended position.

### CROSS-REFERENCE TO RELATED APPLICATIONS

The present application claims priority to co-pending U.S. Provisional Patent Application No. 63/779,874, filed Mar 28, 2025, the entire content of which is incorporated herein by reference.

### FIELD

The present disclosure relates to a battery charger, and particularly, to a battery charger that is configured to receive a removable battery pack from a power tool.

### BACKGROUND

Battery chargers replenish the power of rechargeable batteries in various electronic devices. Typical battery chargers include a power source, charging circuitry, and connectors for the batteries. Due to their size and weight, battery chargers often require careful handling and storage.

### SUMMARY

To address this issue, some battery chargers have been designed with rigid handles that are fixed to the charger housing. While rigid handles may allow a battery charger to be carried and transported more easily, such handles increase the size of the charger and may restrict the ability of the charger to be stored in compact areas, such as vehicles, toolboxes, shelves, etc. As such, there is a need for chargers to incorporate features that improve portability and ease of use, while maintaining a compact design.

In some aspects, the techniques described herein relate to a battery charger including: a housing including a base and a column extending from the base in a height direction, the column including a distal end opposite the base; a plurality of battery interfaces located on at least one of the base or the column, each battery interface of the plurality of battery interfaces configured to receive a battery and provide power to the battery for charging the battery; and a handle assembly coupled to the distal end of the column, the handle assembly including a handle configured to be grasped by a user to carry the battery charger, wherein the handle is movable relative to the housing between a retracted position and an extended position.

In some aspects, the techniques described herein relate to a battery charger including: a housing; a plurality of battery interfaces located on the housing, each battery interface of the plurality of battery interfaces configured to receive a battery and provide power to the battery for charging the battery; and a handle assembly coupled to the housing, the handle assembly including a handle configured to be grasped by a user to carry the battery charger, and first and second end caps fixed to the housing at opposite ends of the handle, wherein the handle is movable relative to the housing and between a retracted position, in which the opposite ends of the handle contact the end caps, and an extended position, in which the opposite ends of the handle are spaced from the end caps.

In some aspects, the techniques described herein relate to a battery charger including: a housing; a battery interface located on the housing, the battery interface configured to receive a battery and provide power to the battery for charging the battery; and a handle assembly coupled to the housing, the handle assembly including a flexible bar and a handle overmolded on the bar, the handle configured to be grasped by a user to carry the battery charger, wherein the handle is movable relative to the housing and between a retracted position and an extended position, wherein a first gap is defined between a midpoint of the handle and the housing when the handle is in the retracted position, wherein a second gap larger than the first gap is defined between the midpoint of the handle and the housing when the handle is in the extended position, and wherein a radius of curvature of the bar decreases when the handle moves from the retracted position toward the extended position.

Other aspects of the disclosure will become apparent by consideration of the detailed description and accompanying drawings.

### BRIEF DESCRIPTION OF THE DRAWINGS

FIG. 1 is a perspective view of a battery charger.

FIG. 2 is a side view of the battery charger of FIG. 1.

FIG. 3 is a front view of the battery charger of FIG. 1.

FIG. 4 is a rear view of the battery charger of FIG. 1.

FIG. 5 is a partial perspective view of the battery charger of FIG. 1, illustrating a handle assembly.

FIG. 6 is a partially exploded perspective view of the handle assembly of FIG. 5.

FIG. 7 is another partially exploded perspective view of the handle assembly of FIG. 5, illustrating internal components of the handle assembly.

FIG. 8 is a rear view of the battery charger of FIG. 1 with a handle of the handle assembly in an extended position.

Before any embodiments of the disclosure are explained in detail, it is to be understood that the disclosure is not limited in its application to the details of an embodiment and the arrangement of components set forth in the following description or illustrated in the following drawings. The disclosure is capable of other embodiments and of being practiced or of being carried out in various ways.

### DETAILED DESCRIPTION

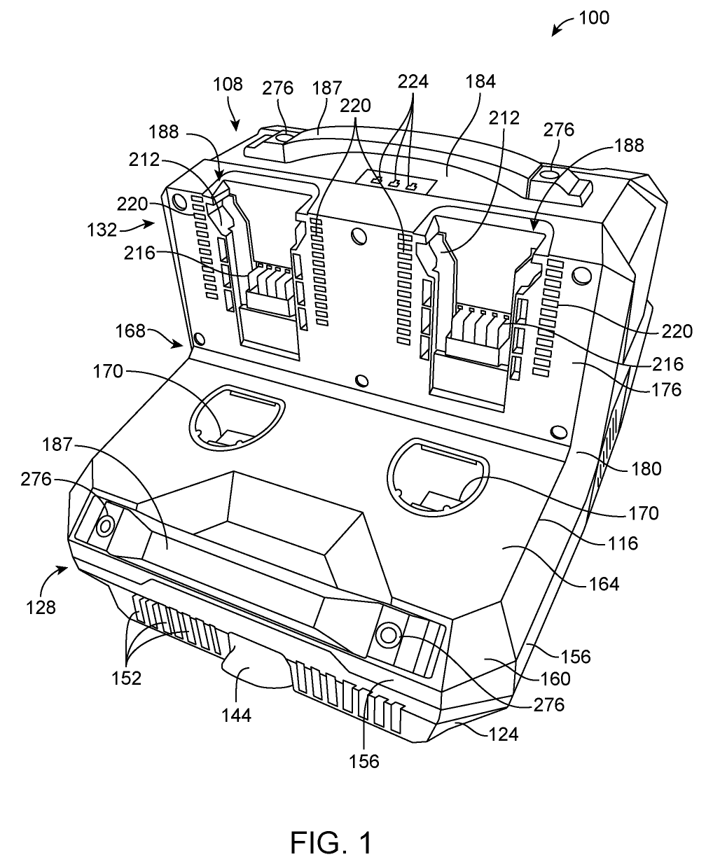

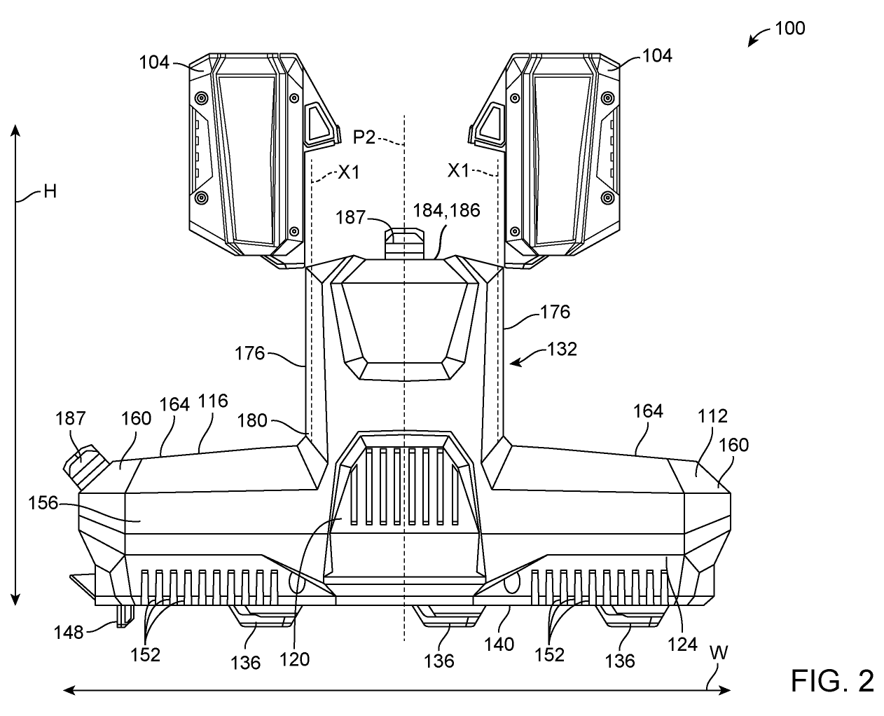

FIGS. 1-4 illustrate a battery charger 100 operable to charge one or more battery packs 104 (FIG. 2) coupled to the battery charger 100. The battery charger 100 includes a housing 108. In the illustrated embodiment, the housing 108 includes a first clamshell 112, a second clamshell 116, intermediate plates 120, and a bottom plate 124. The first and second clamshells 112, 116, the intermediate plates 120, and the bottom plate 124 are coupled together to form a base 128 and a column 132 of the housing 108. In other embodiments, the housing 108 is not limited to the components (e.g., the first and second clamshells 112, 116, the intermediate plates 120, the bottom plate 124) illustrated in FIG. 1. For instance, the base 128 may be constructed of a single piece and the column 132 may be constructed of a single piece coupled to the base 128.

In the illustrated embodiment, the base 128 includes a plurality of cleats 136 extending therefrom (FIGS. 2-4). The illustrated cleats 136 extend from a bottom wall 140 of the base 128. The bottom wall 140 partially defines a plane P1. The bottom wall 140 extends in a width direction W and a length direction L that is transverse (e.g., perpendicular) to the width direction W. The cleats 136 are configured to cooperate with recesses on a support structure. For example, the cleats 136 may be configured to cooperate or interface with a toolbox, a wall plate, or the like of the PACKOUT modular storage system sold by Milwaukee Electric Tool Corporation. The illustrated base 128 includes an actuator 144 having a projection 148 extending downwardly from the bottom wall 140. The actuator 144 and the projection 148 are biased by a spring. In the resting position, the actuator 144 and projection 148 are biased by the spring such that the projection 148 projects from the base 128. A user may retract the projection 148 into the housing by manipulating the actuator 144. The projection 148 is configured to engage and disengage a corresponding recess on the support structure to releasably secure the battery charger 100 to the support structure. In other embodiments, the bottom wall 140 may include other engaging features, such as recesses, rails, or the like, configured to cooperate with corresponding engaging features on the support structure. Accordingly, the battery charger 100 may be securely mounted to the support structure (toolbox, wall plate, etc.) without the use of tools or fasteners.

The base 128 includes a plurality of vents 152. In the illustrated embodiment, vents of the plurality of vents 152 are at least partially disposed on the bottom wall 140. The base 128 includes side walls 156 that extend from the bottom wall 140 in a height direction H. In the illustrated embodiment, the height direction H is transverse (e.g., perpendicular) to the width and length directions W, L. In the illustrated embodiment, the plurality of vents 152 includes vents at least partially disposed on the side walls 156. The base 128 further includes upper walls 164 that extend between the side walls 156 and the column 132. In the illustrated embodiment, a chamfer 160 defines a transition between the side walls 156 and the upper walls 164.

The column 132 extends from the base 128 in the height direction H. Specifically, the column 132 includes side walls 176 extending from the upper walls 164 of the base 128 in the height direction H. In the illustrated embodiment, portions of the side walls 156 of the base 128 extend past the upper walls 164 in the height direction H to form part of the column 132 (e.g., extending between the side walls 176 in the width direction W). The intersection between the walls 164 and the walls 176 may be referred to as a first end 180 of the column 132. The column 132 includes an upper wall 184 extending between the walls 176 and the walls 156. The upper wall 184 is generally parallel to the plane P1 and is disposed at a second end, or distal end 186 that is opposite the first end 180 and opposite the base 128. As discussed in more detail below, a retractable handle assembly 187 is coupled to the upper wall 184, allowing a user to more easily carry and transport the battery charger 100 while maintaining a compact size of the battery charger 100 (e.g., in the height direction H).

Referring to FIG. 1, the illustrated battery charger 100 includes a plurality of battery interfaces 168 disposed on the base 128 and the column 132. In the illustrated embodiment, the plurality of battery interfaces 168 includes a first plurality of battery interfaces 170 recessed into the upper wall 164 of the base 128 and a second plurality of battery interfaces 188 on the side walls 176 of the column 132. The first plurality of battery interfaces 170 may include four battery interfaces 170 (i.e., two battery interfaces 170 on either side of the column 132). The second plurality of battery interfaces 188 may include four battery interfaces 188 (i.e., two battery interfaces 188 on either side of the column 132). As such, in some embodiments, the battery charger 100 may include eight total battery interfaces 168. In other embodiments, the battery charger 100 may include other quantities and/or arrangements of battery interfaces 168. However, the illustrated arrangement of battery interfaces 168 is symmetrical relative to a plane P2 that bisects the base 128 and the column 132 in a width direction W of the battery charger 100 (FIG. 2), which advantageously provides the battery charger 100 with a balanced arrangement that may facilitate carrying and transporting the battery charger 100.

Each battery interface of the second plurality of battery interfaces 188 includes a slot 212 configured to receive the battery pack 104, an aperture 216, and vents 220. In the illustrated embodiment, the slot 212, the aperture 216, and the vents 220 are defined by the walls 176. The slot 212 is configured to receive the battery pack 104 along an insertion axis X1 such that the battery pack 104 may be charged at the respective interface 188 when fully inserted. The second plurality of battery interfaces 188 may include retainers configured to engage latches on the battery pack 104 to retain the battery pack 104 in its fully inserted position until the latches on the battery pack 104 are actuated to permit removal.

The battery pack 104 may include multiple battery cells having, for example, a lithium (Li), lithium-ion (Li-ion), or other lithium-based chemistry. For example, the battery cells may have a chemistry of lithium-cobalt (Li-Co), lithium-manganese (Li-Mn) spinel, or Li-Mn nickel. In such embodiments, each battery cell may have a nominal voltage of about, for example, 3.6V, 4.0V, or 4.2V. In other embodiments, the battery cells may have a nickel-cadmium, nickel-metal hydride, or lead acid battery chemistry. In further embodiments, the battery pack 104 may include fewer or more battery cells, and/or the battery cells may have a different nominal voltage. The battery pack 104 is connectable to and operable to power various motorized power tools (e.g., a cut-off saw, a miter saw, a table saw, a core drill, an auger, a breaker, a demolition hammer, a compactor, a vibrator, a compressor, a drain cleaner, a welder, a cable tugger, a pump, etc.), outdoor tools (e.g., a chain saw, a string trimmer, a hedge trimmer, a blower, a lawn mower, etc.), other motorized devices (e.g., vehicles, utility carts, a material handling cart, etc.), and non-motorized electrical devices (e.g., a power supply, a light, an AC/DC adapter, a generator, etc.). In some embodiments, the battery pack 104 may be an M18 battery pack made and sold by MILWAUKEE ELECTRIC TOOL CORPORATION. In some embodiments, the battery pack 104 may have a nominal output voltage of about 18 Volts.

Each battery interface of the first plurality of battery interfaces 170 includes a recess configured to at least partially receive a stem portion of a second battery pack (not shown). The second battery pack may be similar to the first battery pack 104 but may have a different chemistry, nominal output voltage, form factor, or the like. Thus, the first plurality of battery interfaces 170 and the second plurality of battery interfaces 188 may be configured to receive and charge different types of batteries. In the illustrated embodiment, the first plurality of battery interfaces 170 is configured to receive and charge a battery pack of a nominal output voltage less than the nominal output voltage of the battery pack 104. For example, in the illustrated embodiment, the first plurality of battery interfaces 170 is configured to receive and charge an M12 battery pack made and sold by MILWAUKEE ELECTRIC TOOL CORPORATION. In some embodiments, the second battery pack may have a nominal output voltage of about 12 Volts.

Accordingly, in some embodiments, the battery charger 100 may advantageously receive and charge batteries of different styles, sizes, and/or nominal output voltages, providing enhanced utility for users who may have power tools on different voltage platforms. In other embodiments, however, the first and second pluralities of battery interfaces 170, 188 may be configured to receive and charge the same types of batteries.

Referring to FIG. 1, one or more indicators 224, located on the upper wall 184 in the illustrated embodiment, may indicate the status of the battery pack 104 (e.g., whether the battery pack 104 is fully charged). In some embodiments, the battery charger 100 may include a corresponding indicator 224 for each battery interface of the plurality of battery interfaces 168.

The battery charger 100 includes a printed circuit board (PCB), which may be housed within a PCB enclosure inside the housing 108. The PCB includes electrical connection interfaces, such as a cable or power cord, configured to receive power from an external power source, such as electricity from a wall outlet. In some embodiments, the external power source is a DC power source. In some embodiments, the external power source is an AC power source. For example, the AC power source may be a conventional wall outlet, such as a 120 V outlet or a 240 V outlet. The PCB is electronically coupled to each battery interface of the plurality of battery interfaces 168 such that power is provided to each of the battery interfaces at a voltage and current appropriate for charging the associated battery. The housing 108 may define internal chambers that facilitate airflow, with apertures allowing fluid communication between them. A fan, or multiple fans, may be positioned within the housing 108 to enhance cooling by directing airflow through the chambers.

As discussed above, the handle assembly 187 is coupled to the wall 184 of the column 132. In some embodiments, the handle assembly 187 may alternatively be positioned on the chamfer 160. Additionally, some embodiments may include multiple handle assemblies 187 (e.g., FIGS. 1-3), with one handle assembly 187 positioned on the column 132 and another handle assembly 187 positioned on the chamfer 160. In other variations, the handle assembly 187 may be placed in different locations on the battery charger 100.

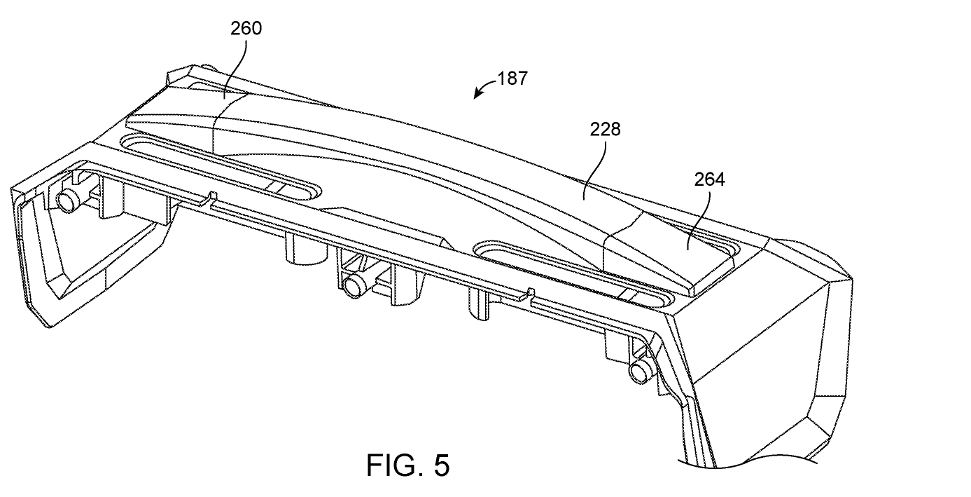

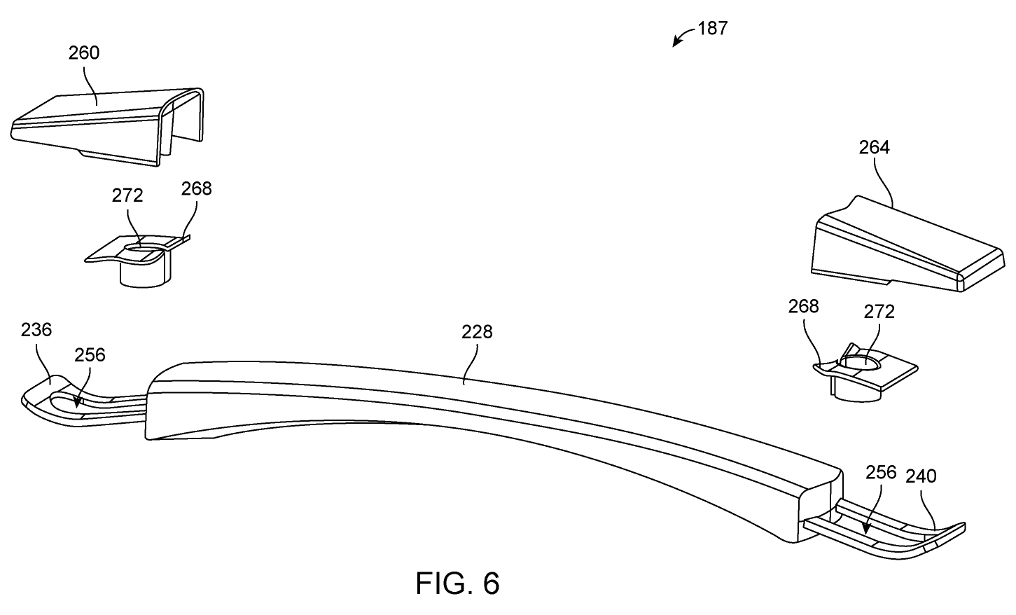

With reference to FIGS. 5-7, the handle assembly 187 includes a handle housing 228, a bar 232, a first guide 236, and a second guide 240. The handle housing 228, which may also be referred to as the handle of the handle assembly 187, is generally elongate and includes an aperture 244 shaped and sized to receive the bar 232. The handle housing 228 may be overmolded over the bar 232 in some embodiments and defines a handle or grip for a user to grasp during use. In some embodiments, the handle housing 228 is made of a flexible plastic or elastomeric material.

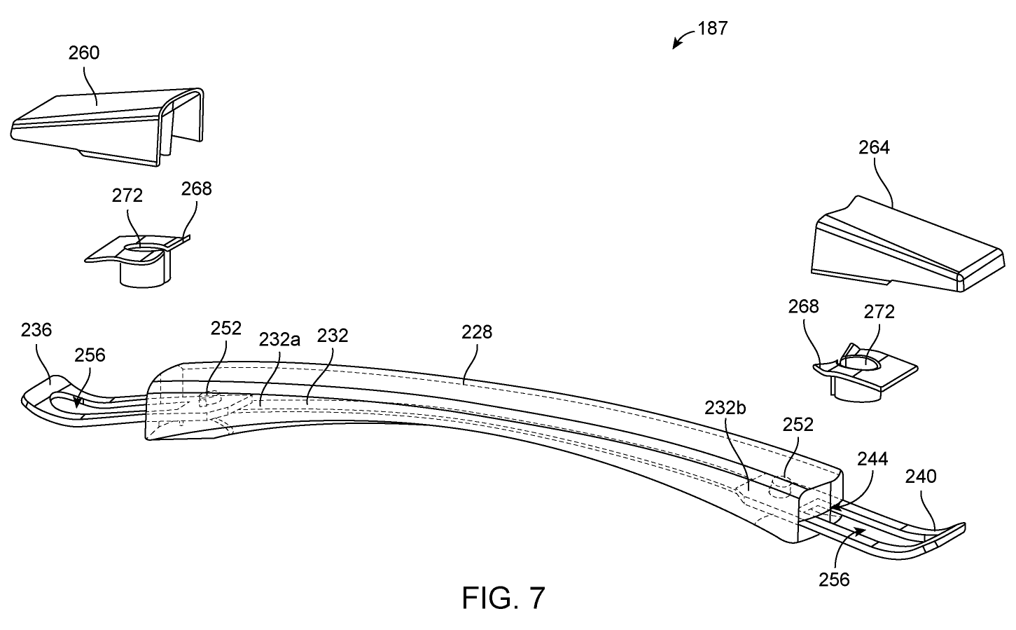

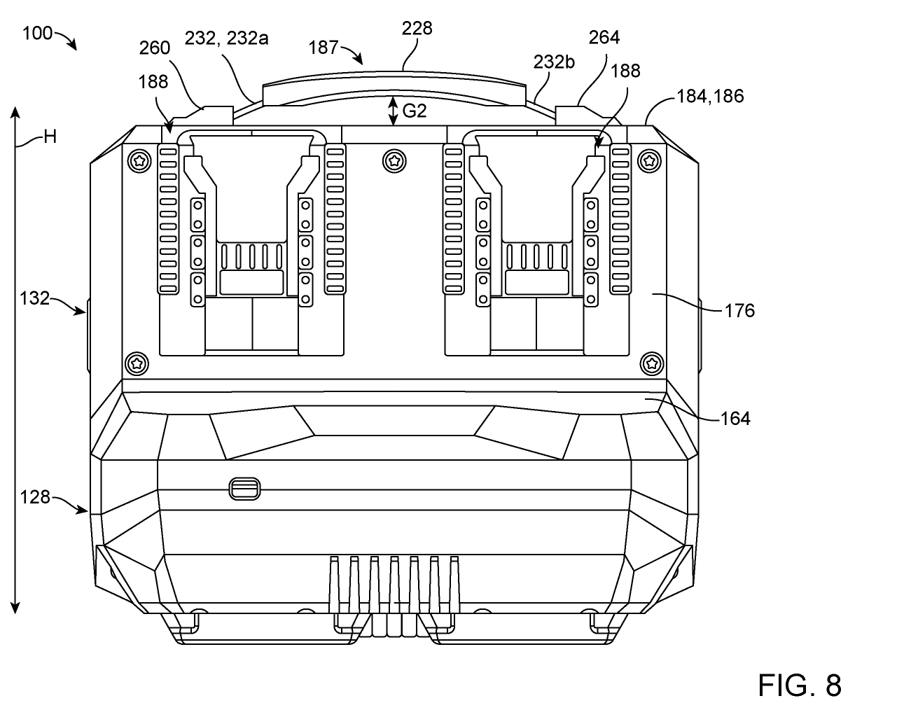

Best illustrated in FIG. 7, the bar 232 is generally elongate and rectangular, defining a first end 232a and a second end 232b opposite the first end. In the illustrated embodiment, the bar 232 is composed of stamped spring steel, such that the bar 232 may flex under load and then resiliently return to its original shape. The bar 232 may alternatively be composed of other materials with similar flexible properties, such as alternative metals, composites, or plastics, that would similarly allow for spring action. As described in greater detail below, the bar 232 is configured to flex away from the upper wall 184 of the column 132 to extend the handle assembly 187 (e.g., to the extended position shown in FIG. 8).

The first guide 236 is coupled to the first end 232a of the bar 232 and the second guide 240 is coupled to the second end 232b of the bar 232. More specifically, the first and second guides 236, 240 are secured to the bar 232 via fasteners 252 (e.g., rivets). The first and second guides 236, 240 are generally rectangular and include a track 256, or slot, extending along the length of the guides 236, 240. The tracks 256 are shaped and sized to accommodate a fastener, as discussed in more detail below.

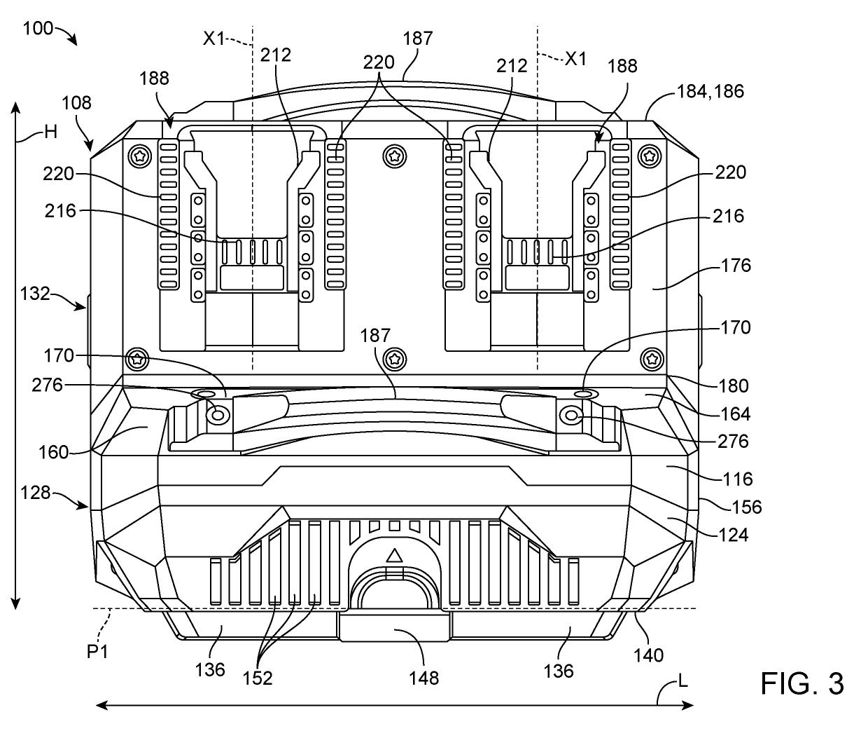

With continued reference to FIGS. 5-7, the handle assembly 187 additionally includes a first end cap 260 coupled to the first guide 236, and a second end cap 264 coupled to the second guide 240. The end caps 260, 264 are fixed to the housing 108 (e.g., to the upper surface 184). The illustrated end caps 260, 264 are shaped and sized to fit over and secure the first and second guides 236, 240 to the housing 108. Each end cap 260, 264 includes a connector 268 configured to couple the end caps 260, 264 to the guides 236, 240. Specifically, each of the connectors 268 includes a threaded aperture 272 shaped and sized to receive a fastener 276 (e.g., a screw) (FIGS. 1 and 3). The fastener 276 extends through the threaded aperture 272 and the tracks 256 into the housing 108, thereby securing the end caps 260, 264 and the guides 236, 240 to the housing 108. In the illustrated embodiments, each end cap 260, 264 includes a single fastener 276. However, in alternate embodiments, the end caps 260, 264 may include additional fasteners.

The connectors 268 are composed of an anti-wear material (e.g., plastic) to minimize wear and friction between the guides 236, 240 and the fasteners 276. As discussed in more detail below, as the handle assembly 187 is manipulated, the guides 236, 240 slide relative to the fasteners 276 via the tracks 256, causing friction at contact points. The anti-wear material provides a buffer between the guides 236, 240 and the fasteners 276, extending the lifespan of the handle assembly 187. In some embodiments, the end caps 260, 264 and/or connectors 268 may be composed of a different material.

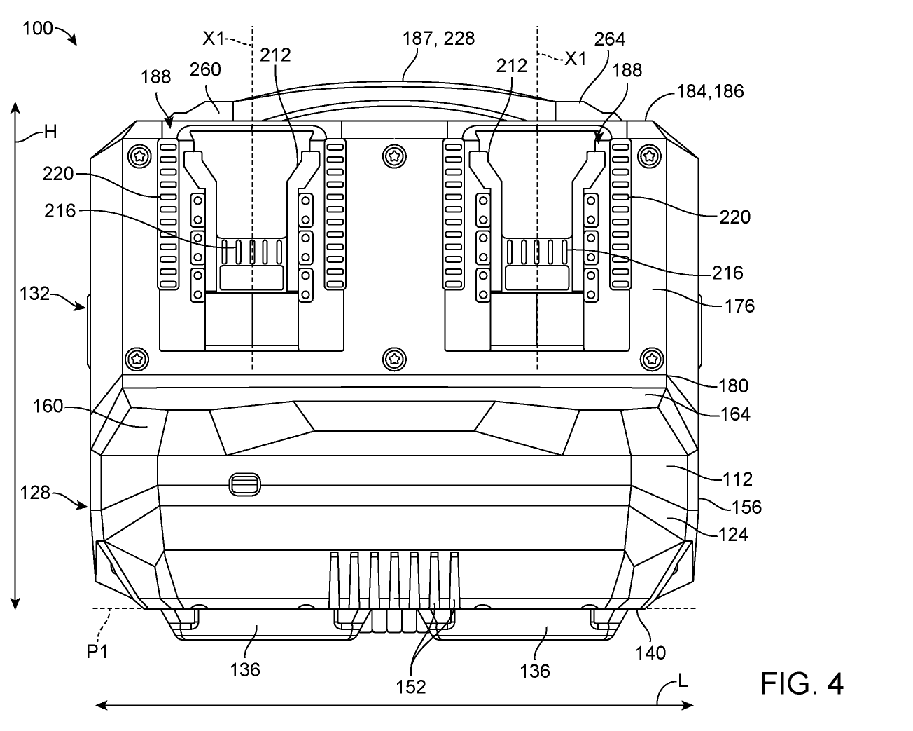

The handle assembly 187 is movable between a retracted position (FIG. 4), which may also be referred to as a first position or stored position, and an extended position (FIG. 8), which may also be referred to as a second position. When the handle assembly 187 is in the stored position, the ends of the handle housing 228 are seated against the end caps 260, 264. In some embodiments, the handle housing 228 may additionally or alternatively engage the housing 108 in the stored position. Conversely, when the handle assembly 187 is pulled to the extended position, the bar 232 flexes, decreasing the radius of curvature of the bar 232 and moving the ends of the handle housing 228 away from the end caps 260, 264 as shown in FIG. 8. This allows the handle housing 228 to be pulled away from the housing 108, creating the gap G2 between a midpoint of the handle housing 228 and the housing 108, which is larger than the gap that may exist when the handle assembly 187 is in the stored position. By increasing the gap (e.g., to the gap G2), sufficient clearance is provided to accommodate a user’s fingers between the handle housing 228 and the housing 108.

To use the handle assembly 187, the user grasps and pulls the handle housing 228 away from the housing 108, applying a pulling force that moves the handle housing 228 from the stored position to the extended position. As this occurs, the first and second guides 236, 240 slide relative to the fasteners 276 along the tracks 256, moving toward each other and extending the handle assembly 187, until distal ends of the tracks 256 abut against the fasteners 276, preventing further movement. The pulling force causes the bar 232 to flex, accommodating the extension while maintaining controlled resistance. The flexure of the bar 232 decreases the radius of curvature of the bar, which causes the ends 232a, 232b of the bar 232 to move away from the end caps 260, 264, and which increases a gap G2 between a midpoint of the handle housing 228 and the upper wall 184 of the column 132. The flexing ensures smooth, low-resistance movement of the bar 232, while the connectors 268 reduce friction between the first and second guides 236, 240 and fasteners 276. The extended position may be maintained by the spring force of the bar 232 and the abutment of the distal end of the tracks 256 against the fasteners 276, holding the handle assembly 187 in place until a force is applied to move the handle assembly 187 to the stored position. In other embodiments, the handle may automatically return to the stored position when the pulling force is removed due to resilient recovery of the bar 232.

As the handle assembly 187 retracts, the bar 232 resiliently recovers, and the first and second guides 236, 240 slide relative to the fasteners 276 along the tracks 256, moving away from each other. The fasteners 276 keep the guides 236, 240 securely aligned relative to the housing 108, preventing misalignment and ensuring a stable retraction. Due to the resilient material of the bar 232, the bar 232 returns to its original shape after flexing, facilitating a smooth and consistent retraction.

Although the disclosure has been described in detail with reference to certain preferred embodiments, variations and modifications exist within the scope and spirit of one or more independent aspects of the disclosure as described.

Various features and aspects of the present disclosure are set forth in the following claims.

What is claimed is:

1. A battery charger comprising:
a housing including a base and a column extending from the base in a height direction, the column including a distal end opposite the base;
a plurality of battery interfaces located on at least one of the base or the column, each battery interface of the plurality of battery interfaces configured to receive a battery and provide power to the battery for charging the battery; and
a handle assembly coupled to the distal end of the column, the handle assembly including a handle configured to be grasped by a user to carry the battery charger,
wherein the handle is movable relative to the housing between a retracted position and an extended position.

2. The battery charger of claim 1, wherein the handle assembly includes first and second end caps fixed to the housing at opposite ends of the handle, and wherein the handle is movable relative to the end caps.

3. The battery charger of claim 2, wherein the handle assembly includes
a bar,
a guide coupled to a distal end of the bar and having an elongate slot, and
a fastener extending through the elongate slot and into the housing.

4. The battery charger of claim 3, wherein the guide is configured to slide relative to the fastener along the slot when the handle moves between the retracted position and the extended position.

5. The battery charger of claim 3, wherein the bar is made of spring steel.

6. The battery charger of claim 3, wherein the handle is movable from the retracted position toward the extended position in response to applying a pulling force to the handle in a direction away from the distal end of the column, wherein the bar is configured to flex under the influence of the pulling force, and wherein flexure of the bar causes the opposite ends of the handle to move away from the end caps.

7. The battery charger of claim 6, wherein the handle is configured to return from the extended position toward the retracted position when the pulling force is removed due to resilient recovery of the bar.

8. The battery charger of claim 1, wherein a first gap is defined between a midpoint of the handle and the housing when the handle is in the retracted position, and wherein a second gap larger than the first gap is defined between the midpoint of the handle and the housing when the handle is in the extended position.

9. The battery charger of claim 1, wherein the plurality of battery interfaces includes a first plurality of battery interfaces located on the base and a second plurality of battery interfaces located on the column.

10. The battery charger of claim 9, wherein the first plurality of battery interfaces is configured to receive and charge batteries having a first nominal output voltage and the second plurality of battery interfaces is configured to receive and charge batteries having a second nominal output voltage greater than the first nominal output voltage.

11. The battery charger of claim 9, wherein the first plurality of battery interfaces includes battery interfaces recessed into an upper wall of the base.

12. The battery charger of claim 9, wherein the second plurality of battery interfaces includes battery interfaces located on opposite sides of the column.

13. The battery charger of claim 1, wherein the housing and the handle assembly are configured such that a plane bisects the base, the column, and the handle assembly.

14. The battery charger of claim 13, wherein the plurality of battery interfaces includes battery interfaces on opposite sides of the plane.

15. A battery charger comprising:
a housing;
a plurality of battery interfaces located on the housing, each battery interface of the plurality of battery interfaces configured to receive a battery and provide power to the battery for charging the battery; and
a handle assembly coupled to the housing, the handle assembly including a handle configured to be grasped by a user to carry the battery charger, and first and second end caps fixed to the housing at opposite ends of the handle,
wherein the handle is movable relative to the housing and between a retracted position, in which the opposite ends of the handle contact the end caps, and an extended position, in which the opposite ends of the handle are spaced from the end caps.

16. The battery charger of claim 15, wherein the handle assembly includes a flexible bar, and wherein the handle is overmolded on the bar.

17. The battery charger of claim 16, wherein the handle is movable from the retracted position toward the extended position in response to applying a pulling force to the handle in a direction away from the housing, wherein the bar is configured to flex under the influence of the pulling force, and wherein the handle is configured to return from the extended position toward the retracted position when the pulling force is removed due to resilient recovery of the bar.

18. The battery charger of claim 17, wherein a first gap is defined between a midpoint of the handle and the housing when the handle is in the retracted position, and wherein a second gap larger than the first gap is defined between the midpoint of the handle and the housing when the handle is in the extended position.

19. The battery charger of claim 15, wherein the housing and the handle assembly are configured such that a plane bisects the housing and the handle assembly, wherein the plurality of battery interfaces includes a first plurality of battery interfaces configured to receive and charge batteries having a first nominal output voltage and a second plurality of battery interfaces configured to receive and charge batteries having a second nominal output voltage greater than the first nominal output voltage, and wherein the first plurality of battery interfaces and the second plurality of battery interfaces each includes battery interfaces located on opposite sides of the plane.

20. A battery charger comprising:
a housing;
a battery interface located on the housing, the battery interface configured to receive a battery and provide power to the battery for charging the battery; and
a handle assembly coupled to the housing, the handle assembly including a flexible bar and a handle overmolded on the bar, the handle configured to be grasped by a user to carry the battery charger,
wherein the handle is movable relative to the housing and between a retracted position and an extended position,
wherein a first gap is defined between a midpoint of the handle and the housing when the handle is in the retracted position,
wherein a second gap larger than the first gap is defined between the midpoint of the handle and the housing when the handle is in the extended position, and
wherein a radius of curvature of the bar decreases when the handle moves from the retracted position toward the extended position.
